(19) United States
(12) Patent Application Publication
(10) Pub. No.: US 2017/0279756 A1
(43) Pub. Date: Sep. 28, 2017

(54) AGGREGATING EMAIL

(71) Applicant: Benjamin Blackhurst RICHARDSON, Austin, TX (US)

(72) Inventor: Benjamin Blackhurst RICHARDSON, Austin, TX (US)

(21) Appl. No.: 15/079,049

(22) Filed: Mar. 24, 2016

(51) Int. Cl. H04L 12/58; H04L 29/08

(52) U.S. Cl. CPC H04L 51/22; H04L 67/02

(57) ABSTRACT

Emails may be received, processed, and made available to users in various web feed formats according to embodiments of the present disclosure.

### CROSS-REFERENCE TO RELATED APPLICATIONS

This application claims the benefit of U.S. Provisional Patent Application Ser. No. 62/177,662, filed Mar. 23, 2015, and titled “Incorporation of email mailbox with RSS feed reading service,” the entire contents of which are hereby incorporated herein by reference.

### BACKGROUND

Field of the Current Disclosure

The present disclosure is generally related to electronic mail (“email”) services. More particularly, the present disclosure is related to services for aggregating incoming emails for a user.

Description of Related Art

Email is a widespread method of exchanging digital communications over computer networks. Email may be used in personal, business, marketing, educational, and other types of communications. A large number of entities attempt to collect email addresses from potential customers so that marketing communications may subsequently be transmitted. Some such entities may unscrupulously share collected email addresses with other marketing companies, resulting in the receipt of many unwanted emails. Such unwanted and unsolicited email may generally be known as “email spam” or “junk email.”

Email spam has the undesirable effect of filling up the recipient's email inbox, making it difficult to identify legitimate communications and/or wasting their time to filter out the email spam. Thus, many people do not wish to receive email spam in the same email inbox they already use for personal and/or business purposes.

### SUMMARY

In one embodiment, a computer-implemented method for managing email is disclosed. The method includes receiving an email directed to a user, associating the received email with the user, converting a text content of the received email to HTML format, and transmitting the converted text content to the user in a web feed.

The present disclosure will now be described more fully with reference to the accompanying drawings, which are intended to be read in conjunction with both this summary, the detailed description, and any preferred or particular embodiments specifically discussed or otherwise disclosed. This disclosure may, however, be embodied in many different forms and should not be construed as limited to the embodiments set forth herein; rather, these embodiments are provided by way of illustration only so that this disclosure will be thorough, and fully convey the full scope thereof to those skilled in the art.

### BRIEF DESCRIPTION OF THE DRAWINGS

Non-limiting and non-exhaustive embodiments of the present disclosure are described with reference to the following FIGURE, wherein like reference numerals refer to like parts throughout the various views unless otherwise specified.

FIG. 1 is a flow chart depicting an embodiment of a process for managing email according to one embodiment of the present disclosure.

Corresponding reference characters indicate corresponding components throughout the several views of the drawings. Skilled artisans will appreciate that elements in the FIGURE are illustrated for simplicity and clarity and have not necessarily been drawn to scale. For example, the dimensions of some of the elements in the FIGURE may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

The present disclosure extends to methods, systems, and computer programs for managing incoming email for a user. In the following description, reference is made to the accompanying drawings that form a part hereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the spirit and scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, or characteristics may be combined in any suitable combinations and/or sub-combinations in one or more embodiments or examples. In addition, it should be appreciated that the FIGURE provided herewith are for explanation purposes to persons ordinarily skilled in the art and that the drawings are not necessarily drawn to scale.

One embodiment of the present disclosure comprises methods and/or systems for aggregating incoming emails directed to a particular recipient by incorporating said emails into a web feed that may then be accessed by the email recipient. Examples of a web feed may include RSS and Atom feeds. In other embodiments, other types and/or formats of web feeds may be utilized.

In embodiments, an email feed service provider may assign a unique user name to each user and associate a unique email address to that user name. The email address may be serviced by the email feed service provider or an agent thereof, or otherwise provided access thereto. The user may supply the assigned email address to any third party from which the user desires to incorporate email into an email web feed. As any third parties transmit email to the provided email address, the email feed service provider may parse any received emails and incorporate the contents of the same into one or more email web feeds to be accessed by the user. In one embodiment, a separate email web feed is generated for each sender. In another embodiment, multiple email web feeds are generated according to subject matter, send date, key words, or any other filtering selections inputted by the user. In another embodiment, a single email web feed is generated for the user. The user may then download and peruse the email web feed in a manner that suits the user, including used a selected web feed reader application.

In one embodiment, at least part of the process for managing incoming emails for a user may be implemented on one or more computing systems and/or one or more mobile computing systems.

An embodiment of the present disclosure comprises a computer processing device and a memory comprising computer-readable instructions directing the processing device to receive emails directed to a user, store emails in an email feed inbound email server, convert email content to Hypertext Markup Language (“HTML”) content, store the HTML content in a database, transmit the HTML content to the user, receive one or more changes to attributes regarding the HTML content, and store the attribute changes in a database. According to various embodiments of the present disclosure, email content can be converted to HTML content on a periodic basis. One embodiment of the present disclosure comprises a computer processing device and a memory comprising computer-readable instructions directing the processing device to assign a unique user identification, which may be referred to herein as a “user ID,” to a new user, create a mailbox identification name, which may be referred to herein as a “mailbox ID,” the mailbox ID being named according to user selection and/or internal rules of the email feed service provider, and generate a new email address for the user mailbox ID by appending the uniform resource locator (“URL”) of the email feed service provider to the user mailbox name.

Embodiments of the present disclosure comprise an email feed inbound email server database adapted to store collected emails for one or more users. As used herein, the term “database” may include, but is not limited to, any data record collection type known at the time of filing, or as developed thereafter, such as, but not limited to, a database implemented on a hard drive or memory; a designated server system or computing system, or a designated portion of one or more server systems or computing systems; a server system network; a distributed database; or an external and/or portable hard drive. Herein, the term “database” can refer to a dedicated mass storage device implemented in software, hardware, or a combination of hardware and software. Herein, the term “database” can refer to an on-line function. Herein, the term “database” can refer to any data storage means that is part of, or under the control of, any computing system, as discussed herein, known at the time of filing, or as developed thereafter.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flowchart in the attached FIGURE illustrate the architecture, functionality, and operation of possible implementations of systems, methods, and computer program products according to various embodiments of the present disclosure. In this regard, each block in the flowchart diagram may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function and/or act specified in the flowchart and/or block diagram block or blocks.

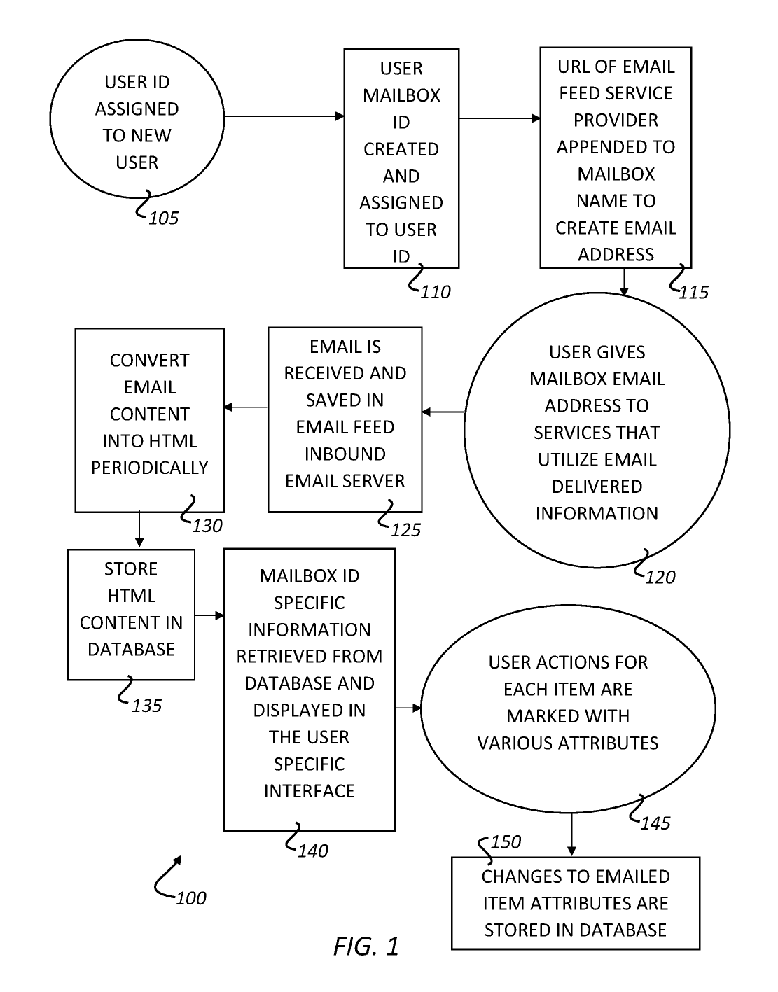

FIG. 1 is a flow chart diagram depicting a process 100 for operating an email web feed system according to various embodiments of the present disclosure. Process 100 for operating an email web feed system begins at USER ID ASSIGNED TO NEW USER 105.

In one embodiment, at least part of process 100 is implemented on a computing system, and/or a mobile computing system.

In one embodiment, at USER ID ASSIGNED TO NEW USER 105, a new user is assigned a unique user ID. In one embodiment, the user ID is stored at a user database with other information relating to the user including the user's name, personal email address(es), contact information, and authentication information such as password hashes. In one embodiment, following USER ID ASSIGNED TO NEW USER 105, process 100 proceeds to USER MAILBOX ID CREATE AND ASSIGNED TO USER ID 110.

In one embodiment, at USER MAILBOX ID CREATED AND ASSIGNED TO USER ID 110, a unique mailbox ID is created and associated with the account of the user ID. In embodiments, the mailbox ID is associated with only one user ID. In embodiments, the user mailbox ID is stored within the user database or other data store.

According to embodiments, the mailbox ID may be submitted by the user but subject to availability and/or approval of the email feed service provider. In some cases, a new user may submit a proposed mailbox ID that is already in use with a different user; in such cases the user is notified and requested to submit another proposed mailbox ID. In some cases, a new user may submit a proposed mailbox ID that contains works and/or characters that are forbidden by internal rules of the email feed service provider; in such cases the user is notified and requested to submit another proposed mailbox ID.

In one embodiment, following USER MAILBOX ID CREATED AND ASSIGNED TO USER ID 110, process 100 proceeds to URL OF EMAIL FEED SERVICE PROVIDER APPENDED TO MAILBOX NAME TO CREATE EMAIL ADDRESS 115. In one embodiment of the present disclosure, at URL OF EMAIL FEED SERVICE PROVIDER APPENDED TO MAILBOX NAME TO CREATE EMAIL ADDRESS 115, a new unique email address is generated for the user. In embodiments, the email feed service provider has a URL for its users. As an example, if a user is assigned a mailbox ID “USER” and the email feed service provider has the URL “EXAMPLE.COM,” the resulting email address may be “USER@EXAMPLE.COM.” In one embodiment, the email address is stored at a database.

In one embodiment, following URL OF EMAIL FEED SERVICE PROVIDER APPENDED TO MAILBOX NAME TO CREATE EMAIL ADDRESS 115, process 100 proceeds to USER GIVES MAILBOX EMAIL ADDRESS TO SERVICES THAT UTILIZE EMAIL DELIVERED INFORMATION 120.

In one embodiment, at USER GIVES MAILBOX EMAIL ADDRESS TO SERVICES THAT UTILIZE EMAIL DELIVERED INFORMATION 120 the user submits the user's email address generated at operation 115 to any service to which the user wishes to subscribe. Such services may include electronic newsletters, marketing lists, online website accounts, and other submission forms requesting an email address. The user may use the generated email address for receiving virtually any correspondence, but it may be particularly suited for receiving automated, recurring email communications. In embodiments, the user may submit the generated email address for any services from which the user expects spam email and does not want to use a personal email address.

In one embodiment, following USER GIVES MAILBOX EMAIL ADDRESS TO SERVICES THAT UTILIZE EMAIL DELIVERED INFORMATION 120, process 100 proceeds to EMAIL IS RECEIVED AND SAVED IN EMAIL FEED INBOUND EMAIL SERVER 125.

In one embodiment, at EMAIL IS RECEIVED AND SAVED IN EMAIL FEED INBOUND EMAIL SERVER 125, services to which the user submitted the generated email address may transmit emails to the generated email address. As said emails are received, they are saved at an email feed inbound server or other type of database. In one embodiment, the saved emails may be associated with the user to whom the emails were directed. In one embodiment, the saved emails may be associated with the email sender.

In one embodiment, following EMAIL IS RECEIVED AND SAVED IN EMAIL FEED INBOUND EMAIL SERVER 125, process 100 proceeds to CONVERT EMAIL CONTENT INTO HTML PERIODICALLY 130.

In one embodiment, at EMAIL IS RECEIVED AND SAVED IN EMAIL FEED INBOUND EMAIL SERVER 125, process 100 proceeds to CONVERT EMAIL CONTENT INTO HTML PERIODICALLY 130, the saved emails are converted into HTML format. In one embodiment, the saved emails are parsed to identify the email sender for subsequent filtering. In one embodiment, the text of the saved emails are cleaned up, for example HTML tags and other metadata are stripped from the saved emails.

In one embodiment, following CONVERT EMAIL CONTENT INTO HTML PERIODICALLY 130, process 100 proceeds to STORE HTML CONTENT IN DATABASE 135.

In one embodiment, at STORE HTML CONTENT IN DATABASE 135, the HTML content from the saved emails is stored in a database. In embodiments, metadata from the saved emails, such as sender information, recipient information, HTML tags, and the like are stored. In one embodiment, the text and/or subject line are stored in a database. According to embodiments, HTML content from the saved emails are associated in a database with the user. In one embodiment, HTML content from the saved emails are associated in a database with the sender.

In one embodiment, following STORE HTML CONTENT IN DATABASE 135, process 100 proceeds to MAILBOX ID SPECIFIC INFORMATION RETRIEVED FROM DATABASE AND DISPLAYED IN THE USER SPECIFIC INTERFACE 140.

In one embodiment, at MAILBOX ID SPECIFIC INFORMATION RETRIEVED FROM DATABASE AND DISPLAYED IN THE USER SPECIFIC INTERFACE 140, the HTML content from saved emails are made available to the user for download. In one embodiment, at MAILBOX ID SPECIFIC INFORMATION RETRIEVED FROM DATABASE AND DISPLAYED IN THE USER SPECIFIC INTERFACE 140, the HTML content from saved emails are added to a web feed that may be accessed by the user, for example, via a feed reader software application. In one embodiment, the email subject line is displayed to the user with the content. Additional metadata may be made available to the user such as receipt date and/or time, sender, and the like. In embodiments, multiple email web feeds are made available to the user, each email web feed being generated according to one or more criteria. For example, a separate email web feed may be generated for each email sender. As another example, a separate email web feed may be generated for one or more subjects to which the email content pertains. Email content may be filtered and/or sorted according to various criteria supplied by each user or according to selections made by the email feed service provider.

In one embodiment, following MAILBOX ID SPECIFIC INFORMATION RETRIEVED FROM DATABASE AND DISPLAYED IN THE USER SPECIFIC INTERFACE 140, process 100 proceeds to USER ACTIONS FOR EACH ITEM ARE MARKED WITH VARIOUS ATTRIBUTES 145.

In one embodiment, at USER ACTIONS FOR EACH ITEM ARE MARKED WITH VARIOUS ATTRIBUTES 145, as the user reviews the content of one or more email web feeds, the user and/or the web feed reader application may submit attributes for each email content. For example, upon the user reading content, the web feed reader application may mark that content as “READ.” Conversely, the user and/or the web feed reader application may mark the content as “UNREAD.” In such cases, the attribute may be transmitted back to the email web feed server. In some cases, the user may select to “star” email content. In other cases, the user may select to save email content. In some cases, the user may select to delete email content. In such cases, the selected attribute can be transmitted back to the email web feed server. In other cases, additional types of attributes may be available for the user to select, which can likewise be transmitted to the email web feed server.

In one embodiment, following USER ACTIONS FOR EACH ITEM ARE MARKED WITH VARIOUS ATTRIBUTES 145, process 100 proceeds to CHANGES TO EMAILED ITEM ATTRIBUTES ARE STORED IN DATABASE 150.

In one embodiment, at CHANGES TO EMAILED ITEM ATTRIBUTES ARE STORED IN DATABASE 150, the selected attribute is received at the email web feed server and associated in the database with the HTML content.

According to various embodiments, email web feed server can await additional emails for subsequent processing at operation 125. According to various embodiments, process 100 may be cycled repeatedly as additional emails are received and as the user continues to submit the generated email address to various services. According to embodiments, operations 105, 110, and 115 may be repeated for multiple users, as each user engages the service of the email feed service provider. In embodiments, each user can create a membership account using his or her personal email ID. Users can log in to their email feed service account using individual login credentials to input preferences according to various service details.

In one embodiment, the inbound email server generates a unique hash as each user account is created. The unique inbound hash may be used to process any email for that user is received.

In one embodiment, a shell script is executed at the email web feed server to convert the received email into HTML template every 5 minutes (or some other designated frequency). A Ruby script (or some other programming command) could parse the email and generate the email web feed for each user.

According to embodiments, a Ruby script (or some other programming command) can convert the HTML template into an XML or some other feed format, including but not limited to API, RSS, Atom, or any of the various methods of transmitting data from publisher to subscriber.

As an example according to some embodiments, if an email that was directed to a particular user is received at the inbound email server from a coupon emailing service, the email can be converted into an XML feed. Individual emails can be displayed as entries in a web feed reader and will be shown in a manner similar to standard RSS/Atom feeds. If another email is subsequently received from the same sender, the email web feed server can checked to ascertain whether that email sender's feed exists or not. If the feed exists then the entries from the new email can be created under the same feed. If the sender's email address is unique, then a new feed channel can be created and logged in the user's database as a new subscription and all subsequent emails from that sender may be attributed to the same sender until the user deletes the subscription.

According to one embodiment, an incoming mail server may accept emails and execute a suffix filter that will save each email to a data store. The web feed server may then execute a Ruby script that runs periodically that will post the email content, which includes all email headers, content, and attachments. The email web feed service provider may choose how the data is parsed, since processing may depend heavily on the use case, programming language, and environment the information is to be displayed in.

Although the present disclosure is described in terms of certain preferred embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the spirit and scope of the present disclosure.

What is claimed is:

1. A computer-implemented method for managing email comprising:
at an email feed inbound email server, receiving an email directed to a user;
at the inbound email server, associating the received email with the user;
at the inbound email server, converting a text content of the received email to HTML format; and
transmitting the converted text content to the user in a web feed.

2. The method of claim 1, wherein the web feed comprises an RSS format feed.

3. The method of claim 1, wherein the web feed comprises an Atom format feed.

4. The method of claim 1, wherein the web feed comprises an XML format feed.

5. The method of claim 1, wherein converting the text content of the received email to HTML format comprises converting text content of a batch of received emails directed to the user to HTML format.
